(19) United States
(12) Patent Application Publication
(10) Pub. No.: US 2024/0058824 A1
(43) Pub. Date: Feb. 22, 2024

(54) DEVICE FOR SHREDDING FIBROUS PLANT MATERIAL

(71) Applicant: Trioliet B.V., Oldenzaal (NL)

(72) Inventor: Robert Jan LIET, Oldenzaal (NL)

(21) Appl. No.: 18/235,854

(22) Filed: Aug. 20, 2023

(30) Foreign Application Priority Data
Aug. 22, 2022 (DE) 102022121143.6

(51) Int. Cl. B02C 23/02

(52) U.S. Cl. CPC B02C 23/02

(57) ABSTRACT

Device for shredding fibrous plant material, in particular hay, straw or silage, comprising a feed for receiving the plant material, a conveying unit and a shredding unit, wherein the conveying unit comprises at least one catch for loosening plant fibers from the fed plant material, and for conveying the plant fibers to the shredding unit, wherein the shredding unit comprises at least two spaced-apart stationary knives, wherein the conveying unit is designed such that the at least one catch can be moved through the spaced-apart stationary knives.

### FILED OF THE INVENTION

The invention relates to a device for shredding fibrous plant material, in particular hay, straw or silage.

### BACKGROUND OF THE INVENTION

Devices for shredding fibrous plant material, in particular hay, straw or silage, are increasingly employed in agriculture. Exemplary devices here comprise a chamber into which food can be introduced via a filling opening, wherein in the chamber, bar-shaped elements move past the filling opening in an endless path. The bar-shaped elements can move through below the food whereby the food is loosened up and/or mixed. A cutting operation is performed when the food is supplied to a cutting element which is arranged near the filling opening. In this manner, the food, in particular the food ingredients consisting of relatively long fibers, such as e. g. grass, is cut. Such a device is known, for example, from EP 0 838 147 A1.

While known devices permit a good shredding of fibrous plant material, shredding is sometimes not satisfactory, in particular with highly compressed food, for example in the form of bales.

### SUMMARY OF THE INVENTION

It is therefore the object of the invention to provide a device for shredding fibrous plant material that provides better shredding.

This object is achieved by a device for shredding fibrous plant material according to the present invention. Advantageous developments can be found in the different embodiments.

So, the invention provides a device for shredding fibrous plant material, in particular hay, straw or silage, comprising a feed for receiving the plant material, a conveying unit and a shredding unit, wherein the conveying unit comprises at least one prong-like catch for loosening plant fibers from the supplied plant material and for conveying the plant fibers to the shredding unit, wherein the shredding unit comprises at least two spaced-apart stationary knives, wherein the conveying unit is designed such that the at least one prong-like catch is movable through the spaced-apart stationary knives.

It turned out that such a device permits a better shredding of fibrous plant material, in particular homogenous shredding. The prong-like catch can in particular more easily loosen plant fibers from the plant material than bar-shaped elements known from prior art. By moving the catch through the two knives, uniform shredding can be achieved as a consequence.

The term “stationary knife” can here be understood such that the knife stands still for the cutting operation in the operation of the device. So, in contrast to a movable knife, a stationary knife is not actively driven for cutting. In other words, a stationary knife can be a fixed knife. To this end, the knife can be in particular mounted to a part of the device, for example a supporting frame, in an immobile manner. However, it is also possible for the stationary knives to be spring-mounted. Thereby, the knives can still be considered as stationary, since they are not driven for the cutting operation even in this case. A stationary knife in particular has the advantage that it can be less prone to wear in operation. In particular, the knives can be individually spring-mounted, and/or at least a portion of the knives can be coherently spring-mounted. This in particular has the advantage that damages of the knives, e. g. by stones, can be reduced.

The shredding unit, in particular the knives of the shredding unit, can be arranged above the conveying surface of the conveying unit. In particular, the knives can be arranged perpendicularly to the conveying surface of the conveying unit. Here, the conveying surface can in particular be understood as the surface of the conveying unit with or along which the plant material can be transported.

The device can in particular be designed as a stationary system, as a shredding robot, or as a trailer, wherein the trailer can be in particular designed to be pulled, or to be self-propelled. The device can comprise a discharge opening, and optionally a discharge conveyor adjacent thereto, so that shredded plant material can be discharged during the drive. In contrast to a trailer, a shredding robot can be moved along a predetermined or predeterminable path in an automated manner. The device can in particular be designed to be used in an agricultural context, e. g. for shredding food bales.

The fibrous plant material can be loose or compressed fibrous plant material, for example hay, straw, lucerne, grass, whole plant silage or other silage. The plant material can be present in the form of bales or blocks. The plant material can be present in various states, e. g. with different humidities, for example as humid grass or dry straw.

By the device, a loosening of the plant material can also be achieved. The device for shredding fibrous plant material can therefore be in particular referred to as a bale loosener.

The feed for receiving the plant material can in particular be arranged at the upper side of the device, in particular above the conveying unit. In particular, the feed can be opened to the top. It is also conceivable that the feed is closable. Such a feed can in particular reduce the escape of dust during the shredding of the plant material. The indications “top” or “upper side” relate to the orientation of the components in operation or an operable state of the device.

The feed for receiving the plant material can have a funnel-shape. The conveying unit can here be arranged under, in particular directly under, the lower opening of the funnel-like receptacle. Thereby, the plant material, in particular in bale form, can be fed to the conveying unit in a centered manner.

In particular, the conveying unit can comprise a conveyor belt, a roller or a conveyor chain. In case of an in particular cylindrical roller, the conveying surface can comprise the lateral area of the roller or be provided by it. The prong-like catches can then extend away from the lateral area of the roller.

The conveying unit can in particular be designed such that it can stop at any time, in particular automatically. Moreover, the conveying unit can in particular be movable against the conveying direction of the plant material typical in operation, that means away from the shredding unit. This in particular has the advantage that by the change of direction, one can try to release a blocking of plant material which would e. g. hinder the conveying unit from moving in the forward direction.

The conveying unit can in particular comprise at least one drive roller and/or deflection roller. In particular, the at least one drive roller and/or deflection roller can move the conveyor belt or the conveyor chain. In other words, the at least one drive roller and/or deflection roller can be part of the drive of the conveying unit. The at least one drive roller can be driven by a motor, for example an electric motor. The at least one drive roller can be driven by a planetary gear or a cylindrical gear. The at least one drive roller and/or deflection roller can in particular be arranged at one end of the conveyor chain or the conveyor belt. For example, the at least one drive roller can be arranged in the region of the shredding unit.

The conveying unit can comprise a closed conveying surface, this in particular means that the plant material can be prevented from passing or falling through the closed conveying surface. In particular, the conveying unit can comprise a conveying surface which is formed by slats adjacent to or adjoining each other in the conveying direction. In particular, the slats can extend transversely to the conveying direction. The slats can connect two parallel drive chains or drive belts. The cross-sectional area of the slats can be selected such that a gap between the adjacent slats is minimized. For example, the slats can have a trapezoidal cross-section, wherein the base (the longer basic side) is arranged at the top, in other words, towards the conveying surface.

Of opposed longitudinal sides of adjacent or adjoining slats, one each can in particular be designed to be concave, and the other one to be convex. Thereby, a gap between the adjacent slats can be minimized. A gap between the slats could in particular occur when the slats move over round objects, e. g. over the drive roller or the deflection roller. Otherwise, in particular material could get through the gap between the slats. At opposed longitudinal sides of adjacent or adjoining slats, a seal, in particular a rubber seal or a plastic seal, could be arranged at least partially. Thereby, a gap between the adjacent slats can be further minimized.

The at least one prong-like catch can in particular extend away from a conveying surface of the conveying unit. In particular, the at least one catch can be arranged perpendicularly on the conveying surface. The at least one catch can in particular be designed as a knife-like element. In particular, the at least one catch can be blunt, that means it does not comprise any cutting edge. The extension of the prong-like catch transverse to the conveying direction can be smaller, in particular smaller by a multiple, than the extension longitudinal of the conveying direction. In other words, the prong can be oriented in the conveying direction.

In particular, the conveying unit can comprise more than one prong-like catch, in particular at least three catches, in particular at least six catches, in particular at least twenty catches. At least a portion of the plurality of catches can be arranged along a line transverse to the transport direction of the conveying unit. At least a portion of the catches can in particular also be arranged to be distributed longitudinally to the transport direction of the conveying unit. In particular, at least a portion of the catches can be arranged, in a plan view onto the conveying surface, in a V shape, a W shape, an X shape, one behind the other or diagonally with respect to the direction of transport of the conveying unit.

In particular, a plurality of catches can each be arranged in a block, in particular in blocks of at least three catches, in particular of at least six catches. Thereby, plant material can be better loosened from the catches and transported to the shredding unit. In particular, a further advantage can be that by adjacent catches, material can be prevented from getting wound around a catch.

The conveying unit can comprise a plurality of such blocks of catches. In particular, the distance of adjacent catches within one block can be smaller than the distance of adjacent blocks with respect to each other. A plurality of blocks of catches can each be arranged on one slat.

At least a portion of the catches arranged in blocks can be arranged as illustrated above in general for the catches. The blocks can be arranged, in particular in a plan view onto the conveying surface, in a V shape, a W shape, an X shape, one behind the other or diagonally with respect to the direction of transport of the conveying unit.

It is also conceivable for the device to comprise more than one conveying unit, in particular two or more conveying units. Here, each one of the conveying units can be designed as described above. In particular, the device can comprise at least two conveying units in the form of rotating rollers whose axes of rotation can be arranged in particular in parallel. In particular, the at least two rollers can be drivable in opposite directions. Thereby, the fibrous plant material, in particular a bale, can be efficiently shredded. At least one shredding unit, in particular at least two shredding units, can be associated with the at least two rollers. In particular, the at least one shredding unit can be arranged between the at least two rollers. This can in particular be the case if the sense of rotation of the rollers is designed such that the catches convey the loosened plant material to the region between the two rollers. It is also conceivable for the at least two rollers to be arranged between the at least two shredding units. This can in particular be the case if the sense of rotation of the rollers is designed such that the catches convey the loosened plant material away from the region between the two rollers.

Between the two rollers, a gap can in particular be formed. Thereby, for example, foreign matter that can be situated in the plant material, e. g. stones, can fall through between the two rollers. In the process, the shredding unit can be in particular arranged outside the gap, e. g. at the sides of the rollers laterally opposed. A receptacle correspondingly arranged under the gap can be provided to collect the foreign matter that has fallen through. This in particular has the advantage that damages of the knives can be prevented.

As already described above, the device can comprise more than one shredding unit, in particular two or more shredding units. In particular, the at least two shredding units can be arranged one behind the other in the direction of transport of the conveying unit. This in particular has the advantage that plant material passes through at least two shredding units one after the other and thus, in particular optimal shredding is possible. It is also conceivable for the two or more shredding units to include different shredding degrees, e. g., the plant material can first pass through a coarse shredding unit and subsequently through a fine shredding unit. The coarse shredding unit can in particular include fewer knives or knives that are further spaced apart from each other than the fine shredding unit.

It would also be conceivable for a coarse shredding unit to be associated with at least one first conveying unit, and a fine shredding unit to be associated with at least one second conveying unit. Thereby, coarsely and finely shredded plant materials can be mixed.

The shredding unit can comprise more than two spaced-apart stationary knives. The knives can be arranged transversely to the direction of transport of the conveying unit.

In particular, the knives can be arranged at regular distances along the complete width of the conveying unit.

It is also possible for the knives to be arranged distributed along a line transverse to the direction of transport of the conveying unit and/or longitudinal to the direction of transport of the conveying unit, in particular arranged in a V shape, a W shape or diagonally in a plan view.

The catches and knives can be arranged relatively with respect to each other such that the length of the shredded plant fibers is constant. This in particular has the advantage that the shredded plant material is preferably homogenous. Moreover, the catches and knives can be arranged relatively with respect to each other such that the plant fibers can be shredded into shorter and longer plant fibers.

It is also possible for the knives to be arranged depending on the arrangement of the prong-like catches. In particular, the knives can be arranged such that each catch performs a shredding operation with at least two knives when it passes the shredding unit. A shredding operation is in particular to be understood as the cutting of fibrous plant material.

The shredding unit can in particular be arranged directly in front of a point where the plant material would leave the conveying unit by force of gravity. For example, the shredding unit can be arranged at the end of a conveying unit designed as a conveyor belt. In case of a conveying unit comprising one or several rollers, the shredding unit can be arranged tangentially to the roller, in particular laterally of the roller or rollers. This in particular has the advantage that shredded plant material can be easily carried away.

The knives and the drive roller can be arranged with respect to each other in such a way that the slats form an interlocking connection with the drive roller during the shredding of plant material. Thereby, tensile forces between the slats can be reduced. In particular, the interlocking connection can be releasable. A releasable interlocking connection can in particular be understood such that the connection can be released again without damaging the components. The drive roller can in particular comprise at least one chain wheel. In particular, each slat can comprise at least one chain link. Here, at least one chain link can be arranged at the outer ends of each slat.

In particular, the chain links can be connected with each other. The at least one chain wheel and the at least one chain link can in particular form an interlocking connection.

In particular, the number of catches and the number of knives can be interdependent. In particular, the number of knives can be determined such that an advantageous shredding of fibrous plant material is possible. For example, the number of knives can be determined such that material conveyed by the catches can be shredded at as many knives as possible. For example, it would be conceivable for each catch to perform one shredding operation with at least two knives.

In particular, the number of catches of the conveying unit and/or the number of knives of the shredding unit can be determined depending on the power of the motor for driving the conveying unit. The catches can be connected with the conveying surface in particular to be releasable without destruction or conditionally releasable without destruction. The knives can in particular be connected with the shredding unit to be releasable without destruction or be conditionally releasable without destruction. Conditionally releasable without destruction can in particular mean that only one auxiliary joined part has to be damaged, but not the components themselves, to release the connection. For example, a rivet can be knocked off to release a rivet connection. This in particular has the advantage that an adaptation of the number of catches and/or knives can be effected with particularly little damage. In particular, the number of catches and/or knives can be reduced if the motor power is not sufficient to be able to drive the conveying unit, in particular in operation. Here, the required motor power can in particular depend on the plant material to be shredded. For example, wet grass can require a higher motor power than dry straw to be shredded.

In particular, the at least one catch can be shaped such that the catch, in particular the surface bearing or supporting the plant material, includes an angle with the two spaced-apart stationary knives, in particular their respective cutting edges. This can in particular permit a gradual shredding, in particular cutting, of the plant material.

In particular, the at least one catch of the conveying unit can be shaped such that particularly much plant material can be loosed and/or conveyed by the at least one catch. It is also possible that the at least one catch is shaped such that as much of the conveyed plant material as possible can be moved through the shredding unit. For example, the at least one catch can be shaped such that fibers can be prevented from getting between a gap that is formed between the shredding unit and the conveying unit. In particular, the at least one catch can be shaped such that it lifts plant fibers. Moreover, the at least one catch can be shaped such that plant material gets centered centrically at the catch. Here, the center of the catch can represent half the length in which the catch extends away from the conveying surface. This in particular has the advantage that more plant material can be shredded since plant material can be lifted and plant material can be prevented from getting between the catch and e. g. a supporting frame where the knives can be mounted, and thus from not being shredded. It is also conceivable that the at least one prong-like catch is designed as a hook, comb, blade, knife or bar arranged perpendicularly to the conveying surface.

The shape of the at least one catch can in particular also depend on the plant material to be shredded, e. g., the at least one catch can have a different shape from that of a catch for dry straw. As described above, the catches can be connected with the conveying surface in particular to be releasable without destruction or to be conditionally releasable without destruction. This in particular has the advantage that an exchange of the catches is possible with little damage. For example, catches which are particularly advantageously shaped for humid grass can be replaced by catches which are particularly advantageously shaped for dry straw.

The at least one catch can in particular be shaped such that the catch can be arranged on the conveying surface rotated by 180° with respect to the vertical line. In particular, the at least one catch can be shaped symmetrically. This in particular has the advantage that the useful life of the at least one catch can be increased since it can be turned, after one side has been worn, and be further operated with the second side as a catch surface.

In particular, the shredding unit can comprise a feed region for the plant material to the shredding unit, wherein the feed region is arranged, in the direction of transport, in front of the at least two spaced-apart stationary knives, and wherein the at least one prong-like catch can be moved through the feed region.

The feed region can in particular have the shape of a channel. To this end, the feed region can in particular be limited to the top, for example by a flat cover element. The shredding unit, in particular the knives of the shredding unit, can be mounted to the flat cover element. In particular, the feed region can extend in the direction of transport of the conveying unit.

The height of the feed region can be constant or decrease, in particular decrease continuously. By a decreasing height, the plant material can in particular be pressed towards the knives. Thereby, the cutting operation can be improved since the plant fibers to be cut then cannot escape to the top. The decrease of the height of the feed region can also be caused by the shape of the knives mounted to the cover element. To this end, the knives can comprise a correspondingly bent region in front of the cutting edge. For example, the feed region can have a maximum height between 5 cm and 30 cm, in particular between 5 cm and 20 cm, in particular between 5 cm and 15 cm. The feed region can have this maximum height in particular at its opening, related to the conveying direction of the conveying unit.

In particular, the height of the feed region can decrease in the direction of transport of the conveying unit, in particular decrease linearly, in particular decrease by an amount that corresponds to the covered path in the direction of transport of the conveying unit. The relation between the length of the feed region to the height at its opening can be between 0.5 and 5, in particular between 0.8 and 4, in particular between 1 and 3. Here, the length of the feed region can in particular be understood as the section between the opening and the cutting edge of the knives.

The invention moreover provides a use of the above-described device for shredding fibrous plant material, in particular hay, straw or silage.

The device for shredding fibrous plant material can here include one or several ones of the above mentioned features.

The invention furthermore provides a method for shredding fibrous plant material, in particular hay, straw or silage, with an above-described device. Here, the method can in particular comprise the steps that the plant material is received in a feed, that plant fibers are loosened from the fed plant material and are conveyed to a shredding unit, and that the plant fibers are shredded with the aid of the shredding unit.

The device for shredding fibrous plant material can in turn include one or several ones of the above mentioned features.

### BRIEF DESCRIPTION OF THE DRAWINGS

Further features and advantages of the invention will be described below with reference to the exemplary figures. In the drawings:

FIG. 1 shows an exemplary device for shredding fibrous plant material in a schematic representation,

FIG. 2 shows an exemplary shredding unit in a schematic representation,

FIG. 3 shows exemplary catches in a schematic representation,

FIG. 4a shows a further exemplary device for shredding fibrous plant material in a schematic representation,

FIG. 4b shows an exemplary conveying unit with concave and convex slats in a schematic representation,

FIG. 5 shows a further exemplary device for shredding fibrous plant material in a schematic representation, and

FIG. 6 shows a further exemplary device for shredding fibrous plant material in a schematic representation.

### DETAILED DESCRIPTION OF THE PREFERRED EMBODIMENTS

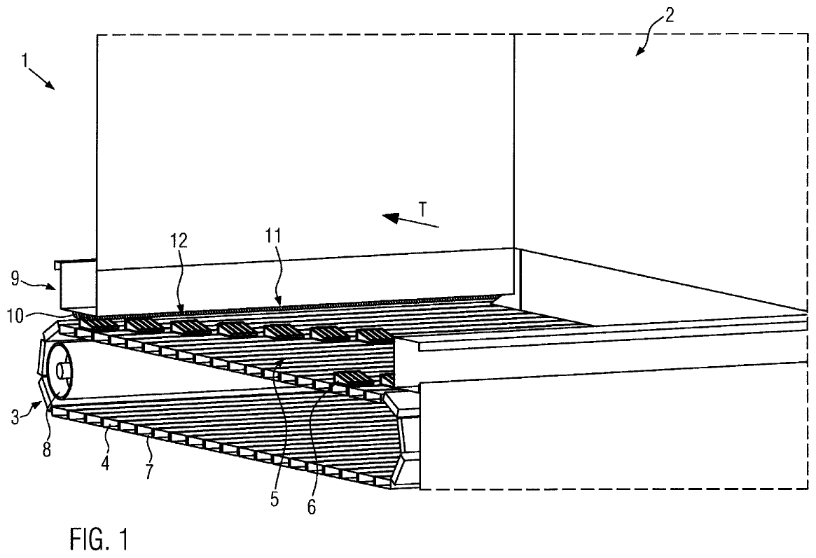

FIG. 1 schematically shows an exemplary device 1 for shredding fibrous plant material, such as hay, straw or silage. The device 1 comprises a feed 2 for receiving the plant material, and a conveying unit 3. In this example, the feed 2 is arranged above the conveying unit 3 and opened to the top.

Here, the conveying unit 3 comprises a conveyor chain 4 with a closed conveying surface 5 and prong-like catches 6. The catches 6 extend away from the conveying surface 5 and are arranged in blocks diagonally to the direction of transport T of the conveyor chain 4. The direction of transport T shows the conveying direction of the plant material typical in operation. The conveyor chain 4 is drivable via a non-depicted drive. For example, the conveyor chain 4 can be driven via a planetary gear or cylindrical gear with a motor, in particular an electric motor. The conveying surface 5 is formed by adjacent slats 7. The slats 7 can move over deflection rollers 8 which stiffen the conveying unit 3.

The device 1 furthermore comprises a shredding unit 9 comprising spaced-apart stationary knives 10. The knives 10 are arranged at regular distances along the complete width of the conveying unit 3 above the conveying surface 5. The sharpened edges of the knives 10, that means the cutting edges thereof, are arranged opposed to the direction of transport T. The catches 6 can be moved through the knives 10.

Moreover, the shredding unit 9 comprises a feed region 11 for the plant material. The latter is arranged in front of the knives 10 and extends in the direction of transport T. The catches 6 can be moved through the knives 11. The feed region has the shape of a channel and is limited to the top by a flat cover element 12. The knives 10 are mounted to the flat cover element 12.

In operation, plant material fed by the feed 2 is usually loosened by the catches 6 and conveyed to the shredding unit 9. The plant material to be shredded can in particular be hay, straw or silage, for example in the form of bales or blocks. Subsequently, the catches 6 move through the shredding unit 9, in particular through the knives 10, whereby the plant material, in particular the loosened plant fibers, is shredded.

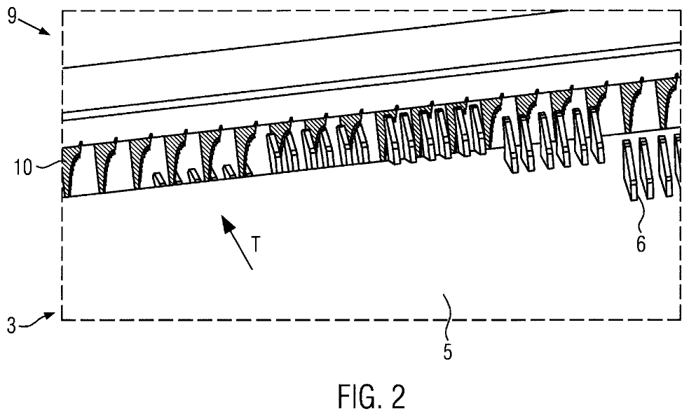

FIG. 2 schematically shows an exemplary shredding unit 9. It comprises knives 10 which are arranged perpendicularly to the direction of transport T of a conveying unit 3. The conveying unit 3 is in this example designed as a roller and comprises a closed conveying surface 5 and catches 6 arranged thereon. The catches 6 are arranged in several blocks diagonally to the direction of transport T and can be moved through the knives 10.

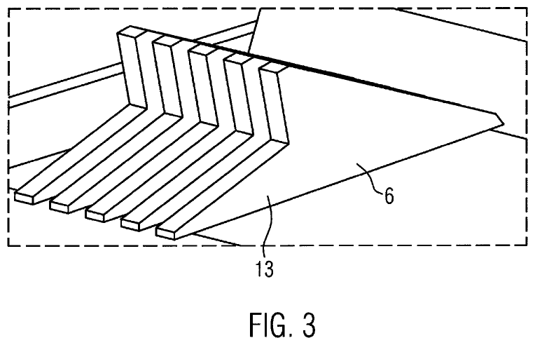

FIG. 3 schematically and by way of example shows a block of prong-like catches 6. These are arranged at regular distances with respect to each other and shaped such that plant fibers can be lifted. A receiving tip 13 extending in the direction of transport T can move under the plant fibers and lift them.

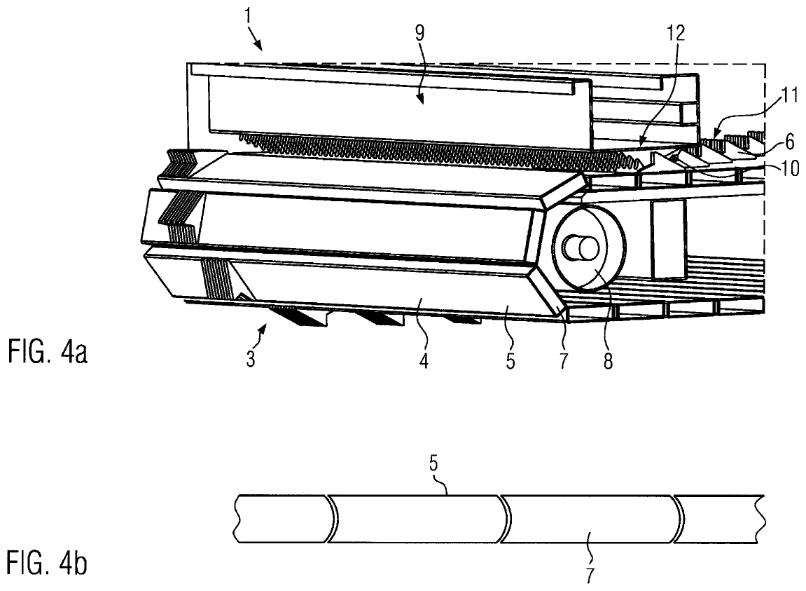

FIG. 4a shows a further exemplary device 1 for shredding fibrous plant material. The device 1 comprises a conveying unit 3 comprising a conveyor chain 4 with a closed conveying surface 5. On the conveying surface 5, prong-like catches 6 are arranged which extend away from the conveying surface 5 and are arranged in blocks diagonally to the direction of transport T. The conveying surface 5 is formed by adjacent slats 7. These can move over deflection rollers 8 which stiffen the conveying unit 3. The cross-sectional area of the slats 7 in parallel to the direction of transport T is, for example, rectangular with rounded corners. However, it would also be conceivable for the cross-sectional area of the slats 7 to be trapezoidal in parallel to the direction of transport T, with a base arranged to the top.

The device 1 furthermore comprises a shredding unit 9 comprising spaced-apart stationary knives 10. The knives 10 are arranged at regular distances along the complete width of the conveying unit 3. The sharpened edges of the knives 10 are arranged against the direction of transport T. The catches 6 can be moved through the knives 10.

Moreover, the shredding unit 9 comprises a feed region 11 for the plant material. The latter is arranged in front of the knives 10 and extends in the direction of transport T. The catches 6 can be moved through the knives 10. The feed region has the shape of a channel and is limited to the top by a flat cover element 12. The knives 10 are mounted to the flat cover element 12. The decrease of the height of the feed region 11 is caused by the shape of the knives 10.

FIG. 4b schematically shows a cross-section through exemplary slats 7 in parallel to the direction of transport T. Of opposed longitudinal sides of adjacent slats 7, one each is concave and the other one convex. The conveying surface 5 of the slats 7 is closed.

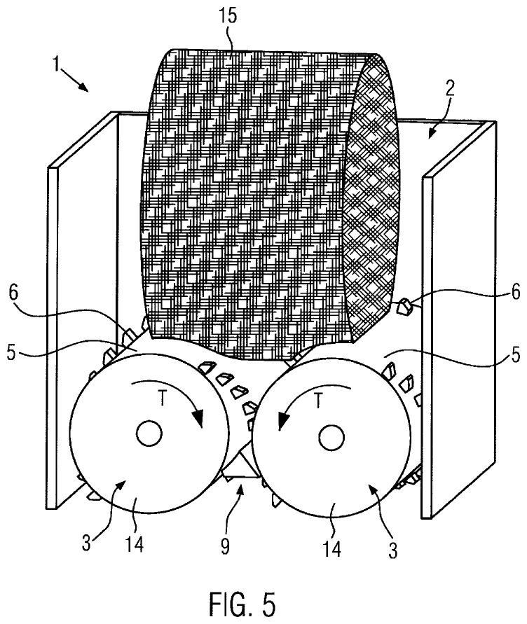

FIG. 5 shows a further exemplary device 1 for shredding fibrous plant material. The device 1 comprises a feed 2 in the form of a container open to the top for receiving the plant material, such as, for example, bales 15, and two conveying units 3. In this example, the feed 2 is arranged above the two conveying units 3 and opened to the top.

The conveying units 3 each comprise a roller 14 with closed conveying surfaces 5 and prong-like catches 6. The directions of transport T show the sense of rotation of the respective roller 14, wherein the two rollers 14 can be driven in opposite directions. The catches 6 extend away from the conveying surface 5 and are arranged in blocks diagonally to the direction of transport T of the conveying surface.

Furthermore, the device 1 comprises a shredding unit 9 which is arranged between the two rollers 14 and comprises spaced-apart stationary knives 10 (not depicted). The catches 6 can be moved through the shredding unit 9. The knives 10 are arranged such that at least a portion of the catches 6 of the first roller 14 can be moved through the knives 10, and at least a portion of the catches 6 of the second roller 14 can be moved though the knives 10.

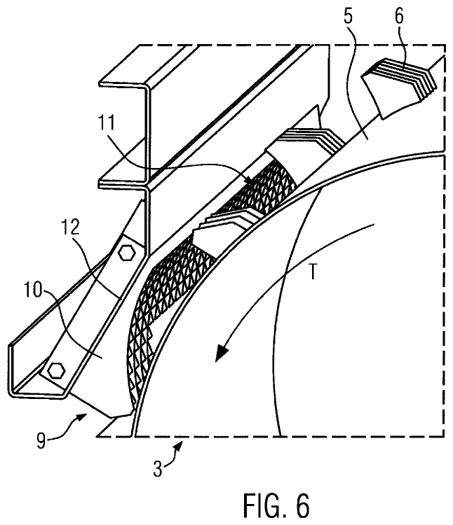

FIG. 6 schematically shows a further exemplary device in a detailed view. The device 1 comprises a conveying unit 3 and a shredding unit 9. The conveying unit 3 comprises prong-like catches 6 which extend away from the closed conveying surface 5.

The shredding unit 9 comprises spaced-apart stationary knives 10 through which the catches 6 can be moved. The direction of transport T shows the typical moving direction of the catches 6 in operation. The knives 10 are arranged at regular distances along the complete width of the conveying unit 3. The cutting edges of the knives 10 are arranged opposed to the direction of transport T and have a jagged design.

Moreover, the shredding unit 9 comprises a feed region 11 for the plant material. The latter is arranged in front of the knives 10 and extends in the direction of transport T. The catches 6 can be moved through the knives 10. The feed region has the shape of a channel and is limited to the top by a flat cover element 12. The knives 10 are mounted to the flat cover element 12. The decrease of the height of the feed region 11 is caused by the bent shape of the knives 10.

It will be understood that features mentioned in the above-described exemplified embodiments are not restricted to these special combinations and are also possible in any other combinations.

### LIST OF REFERENCE NUMERALS

1 device
2 feed
3 conveying unit
4 conveyor chain
5 conveying surface
6 catch
7 slats
8 drive roller or deflection roller
9 shredding unit
10 knife
11 feed region
12 cover element
13 extension in the direction of transport T
14 roller
15 bale
T direction of transport

What is claimed is:

1. Device for shredding fibrous plant material, in particular hay, straw or silage, comprising:
a feed for receiving the plant material,
a conveying unit,
a shredding unit,
wherein the conveying unit comprises at least one prong-like catch for loosening plant fibers from the fed plant material and for conveying the plant fibers to the shredding unit, and
wherein the shredding unit comprises at least two spaced-apart stationary knives, wherein the conveying unit is designed such that the at least one prong-like catch can be moved through the spaced-apart stationary knives.

2. Device according to claim 1, wherein:
the conveying unit comprises a roller.

3. Device according to claim 1, wherein:
the conveying unit comprises a conveyor belt or a conveyor chain, wherein the conveying unit in particular comprises a closed conveying surface.

4. Device according to claim 3, wherein:
the conveying unit comprises a conveying surface which is formed by slats adjacent or adjoining in the conveying direction.

5. Device according to claim 4, wherein:
of opposed longitudinal sides of adjacent or adjoining slats, one each is concave and the other one convex.

6. Device according to claim 1, wherein:
a plurality of catches are arranged along a line transverse to the direction of transport of the conveying unit.

7. Device according to claim 1, wherein:
a plurality of catches are arranged longitudinally to the direction of transport of the conveying unit, in particular arranged in a V shape, W shape or diagonally in a plan view onto the conveying surface.

8. Device according to claim 1, wherein:
a plurality of catches are each arranged in a block, and wherein the conveying unit comprises a plurality of such blocks of catches, in particular in blocks of at least three catches, in particular of at least six catches, and wherein the distance of adjacent catches within one block is smaller than the distance of adjacent blocks with respect to each other.

9. Device according to claim 1, wherein:
the device comprises two conveying units in the form of rotating rollers, wherein the shredding unit is arranged between the two rollers, or the two rollers are arranged between two shredding units.

10. Device according to claim 1, wherein:
a plurality of spaced-apart stationary knives are provided which are arranged transverse to the direction of transport of the conveying unit, in particular at regular distances along the complete width of the conveying unit.

11. Device according to claim 10, wherein:
the spaced-apart stationary knives are arranged distributed along a line transverse to the direction of transport of the conveying unit, and/or longitudinal to the direction of transport of the conveying unit, in particular arranged in a V shape, W shape or diagonally in a plan view.

12. Device according to claim 1, wherein:
the shredding unit comprises a feed region for the plant material to the shredding unit, wherein the feed region is arranged in front of at least two spaced-apart stationary knives, and wherein the at least one prong-like catch can be moved through the feed region.

13. Device according to claim 12, wherein:
the feed region has a channel shape and is limited to the top.

14. Device according to claim 1, wherein:
the device for shredding fibrous plant material is a drawn or self-propelled vehicle, a shredding robot, or a stationary system.

15. Use of a device according to claim 1 for shredding fibrous plant material, in particular hay, straw or silage.

16. Method for shredding fibrous plant material, in particular hay, straw or silage, with a device according to claim 1, the method comprising the steps of
receiving the plant material in a feed,
loosening plant fibers from the fed plant material and conveying the plant fibers to a shredding unit, and
shredding the plant fibers with the aid of the shredding unit.

17. A device for shredding fibrous plant material comprising:
a feed region configured to receive the fibrous plant material;
a conveying unit comprising a conveying surface having a width;
a shredding unit positioned to receive the conveying surface of the conveying unit, said shredding unit comprising a plurality of knives positioned in said shredding unit along the width of the conveying surface;
a plurality of catches attached to the conveying surface and extending away from the conveying surface, said plurality of catches configured to move through the plurality of knives positioned in said shredding unit; and
wherein each of said plurality of catches comprise a ramped receiving tip portion extending towards the plurality of knives and a ramped trailing portion extending away from the plurality of knives and wherein the ramped trailing portion extends higher from the conveying surface than the ramped receiving tip portion, whereby the ramped receiving tip portion is capable of moving under the fibrous plant material lifting the fibrous plant material into the plurality of knives and the ramped trailing portion is capable of preventing the fibrous plant material from passing over said plurality of catches when moving through the plurality of knives.

18. A device for shredding fibrous plant material according to claim 17 wherein:
said plurality of catches are arranged in blocks of multiple catches wherein a catch distance between adjacent catches within one of the blocks of multiple catches is smaller than a block distance between adjacent blocks of multiple catches.
